(19) United States
(12) Patent Application Publication
(10) Pub. No.: US 2009/0033569 A1
(43) Pub. Date: Feb. 5, 2009

(54) Electronic Apparatus

(75) Inventors: Hironori Motoe, Ome-shi (JP); Toshiyuki Hirota, Hino-shi (JP); Toshio Ooe, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/131,806

(22) Filed: Jun. 2, 2008

(30) Foreign Application Priority Data
Jul. 31, 2007 (JP) 2007-199542

(51) Int. Cl. H01Q 1/24

(52) U.S. Cl. 343/702

(57) ABSTRACT

An electronic apparatus includes a housing that has a corner, a first side extending from the corner, and a second side extending from the corner, and an antenna provided in the housing. The antenna is formed in an area located along the first side and apart from the corner by at least 15% of a size of the first side.

### CROSS-REFERENCE TO RELATED APPLICATIONS

This application is based upon and claims the benefit of priority from Japanese Patent Application No. 2007-199542, filed Jul. 31, 2007, the entire contents of which are incorporated herein by reference.

### BACKGROUND

1. Field

One embodiment of the invention relates to an electronic apparatus with an antenna for radio communication.

2. Description of the Related Art

Jpn. Pat. Appln. KOKRAI Publication No. 2003-202938, for example, discloses a portable information processing apparatus with a housing containing an antenna. The information processing apparatus comprises a main unit, and a display unit rotatably attached to the main unit. The display unit includes a display device, a front housing surrounding the front surface of the display device, a rear housing covering the rear surface of the display device, and a cover covering the side surfaces of the display device. The front and rear housings have notches at positions corresponding to the side surfaces of the display devices. The notches contain an antenna for radio communication. The above-mentioned cover covers the notches containing the antenna.

In the conventional information processing apparatus, the antenna does not protrude to the outside of the display unit. Accordingly, the antenna is protected even when the information processing apparatus falls down.

However, in the information processing apparatus, it is necessary to provide notches in the front and rear housings, and to cover them, which makes the housings complex. Further, a number of standards have recently been used for radio communication, and a large number of types of antennas corresponding to the standards have come to be required. It is difficult to provide various types of antennas in the above-mentioned structure, and hence there is a demand for improvement of the structure.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating a portable computer as an example of an electronic apparatus according to a first embodiment of the invention;

FIG. 2 is an exemplary perspective view illustrating the portable computer of FIG. 1 when seen from the rear side thereof;

FIG. 3 is an exemplary plan view illustrating the inside of the rear cover of the portable computer of FIG. 2;

FIG. 4 is an exemplary enlarged plan view illustrating each antenna provided on the rear cover of FIG. 3;

FIG. 5 is an exemplary side view illustrating the state of the main unit of the portable computer of FIG. 1 assumed in a drop test immediately before it collides with the floor;

FIG. 6 is an exemplary side view illustrating the state of the main unit of the portable computer of FIG. 5 assumed when it collides with the floor;

FIG. 7 is an exemplary table illustrating the results of the drop test shown in FIGS. 5 and 6;

FIG. 8 is an exemplary perspective view illustrating a modification of the portable computer of the first embodiment;

FIG. 9 is an exemplary sectional view illustrating a display unit incorporated in the portable computer of FIG. 8;

FIG. 10 is an exemplary plan view illustrating the inside of the rear cover of a portable computer as an example of an electronic apparatus according to a second embodiment of the invention;

FIG. 11 is an exemplary perspective view illustrating a portable telephone as an example of an electronic apparatus according to a third embodiment of the invention; and

FIG. 12 is an exemplary plan view illustrating the inside of the rear cover of the portable telephone shown in FIG. 11.

### DETAILED DESCRIPTION

Various embodiments according to the invention will be described hereinafter with reference to the accompanying drawings. In general, according to one embodiment of the invention, an electronic apparatus includes a housing that has a corner, a first side extending from the corner, and a second side extending from the corner; and an antenna provided in the housing. The antenna is formed in an area located along the first side and apart from the corner by at least 15% of a size of the first side.

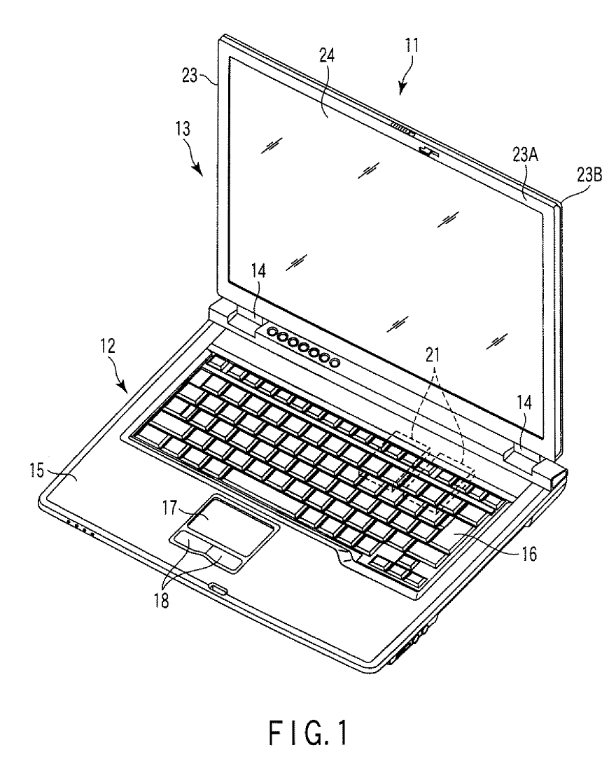

Referring first to FIGS. 1 to 9, a portable computer as an example of an electronic apparatus according to a first embodiment will be described. As shown in FIG. 1, the portable computer denoted by reference number 11 comprises a main unit 12, a display unit 13, and hinges 14 interposed therebetween. The hinges 14 support the display unit 13 so that the unit 13 can rotate relative to the main unit 12.

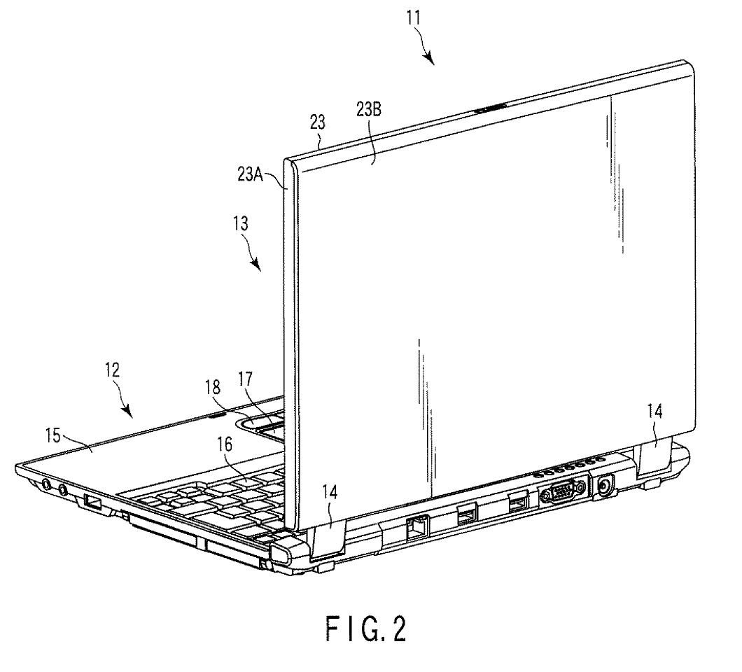

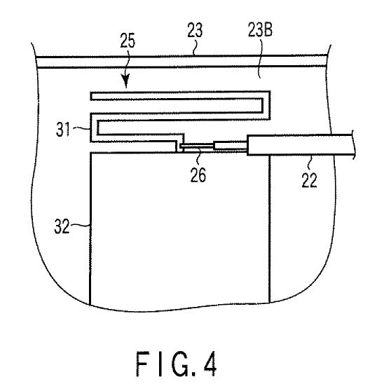

The main unit 12 includes a main unit cabinet 15 made of a resin, a keyboard 16, a touch pad 17 as a pointing device, and buttons 18. The main body cabinet 15 has a conductive ground layer on its inner surface. The cabinet 15 of the main unit 12 contains a printed circuit board (not shown), a plurality of electronic components (not shown), and radio modules 21 (see FIG. 2), The main unit 12 further includes coaxial cables 22 (FIG. 4) interposed between the main unit 12 and the display unit 13. Each coaxial cable 22 has a signal line 26. The signal line 26 has an end connected to the radio modules 21, and the other end connected to antenna elements 31 incorporated in antennas 25, which will be described later.

The display unit 13 comprises a display cabinet 23 made of a resin, a liquid crystal display 24 contained in the display cabinet 23, and a plurality of antennas 25 built in the display cabinet 23. The display cabinet 23 has a front cover 23A and a rear cover 23B. The housing that will hereinafter be referred to includes the main unit cabinet 15 and the display cabinet 23.

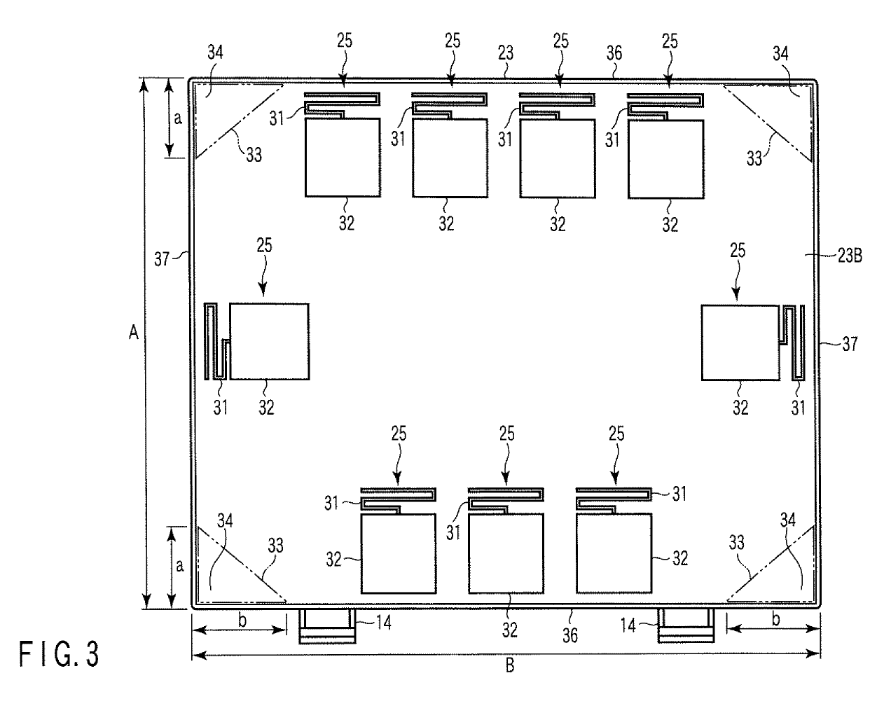

As shown in FIGS. 3 and 4, the antennas 25 are formed on the rear cover 23B of the display cabinet 23. The antennas 25 are formed of metal films and provided on the inner surface of the rear cover 23B. Each antenna 25 comprises an antenna element 31 for transmitting/receiving electromagnetic waves, and an antenna ground 32 connected to the ground portion of the corresponding coaxial cable 22. Each antenna 25 is formed on the display cabinet 23 by, for example, inmold printing such as IMR or IMF, vapor deposition, plating or sputtering. Further, each antenna 25 may be formed by stacking, for example, copper, nickel and metal thin films using screen printing.

As shown in FIG. 3, the display cabinet 23 has four corners 34, first sides 36 extending between adjacent pairs of corners 34, and second sides 37 extending between adjacent pairs of corners 34 and being perpendicular to the first sides 36. The display cabinet 23 also has substantially triangular margin areas 33 at the corners 34. One side of each margin area 33 has a size a equal to 15% of the width A of the cabinet 23, and another side of each margin area 33 perpendicular to the one side has a size b equal to 15% of the length B of the cabinet 23.

The antennas 25 are formed in areas of the display cabinet 23 other than the margin areas 33. Namely, the antennas 25 are formed in areas apart from the respective corners 34 by at least 15% of the sizes of the first and second sides 36 and 37. The respective antennas 25 correspond to various schemes including communication schemes, such as Bluetooth (trademark), wireless LAN, wireless WAN, WiMAX, UWB and GPS, and portable telephone schemes, such as 3G and 3.5G. However, the communication standards, to which the antennas 25 correspond, are not limited to the above, but may include other standards. In the embodiment, the antennas 25 are provided at positions apart from the margin areas 33 and close to the periphery of the display cabinet 23 as part of the housing. However, the positions of the antennas 25 are not limited to those close to the periphery of the display cabinet 23, but may be any other positions if they are apart from the margin areas 33 and can acquire a necessary directivity.

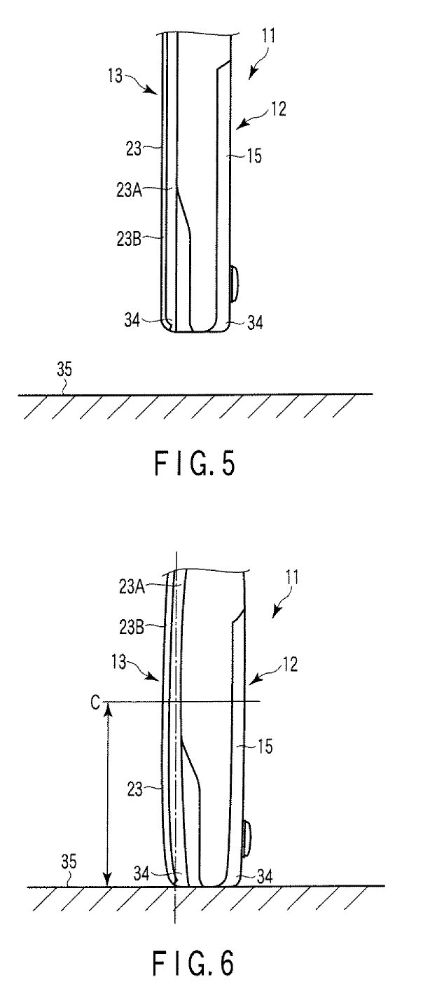

Referring then to FIGS. 5 to 7, a description will be given of the results of a drop test conducted on the portable computer 11. In the drop test, the portable computer 11 was dropped from a preset height, e.g., from the top of a desk. As shown in FIG. 5, when the portable computer 11 is dropping, the main unit cabinet 15 is not deformed.

FIG. 6 is a schematic view illustrating the state of the portable computer 11 assumed just when it collides with a floor 35, with the main unit 12 and the display unit 13 closed. When the portable computer 11 drops on the floor 35, the portion of the computer 11 colliding with the floor 35 will easily crack. In particular, the inventors found that the portions C of the main unit cabinet 15 and display cabinet 23, which are away from the portions colliding with the floor by 15% of the entire lengths and widths of the cabinets, will be deformed at maximum.

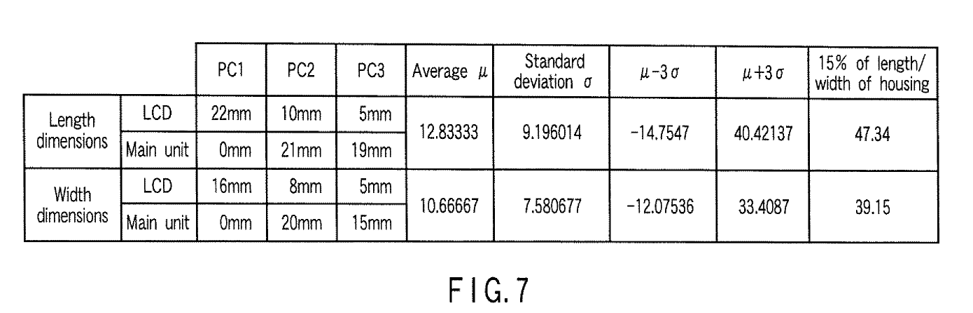

FIG. 7 is a table showing the results of drop tests conducted on three portable computer samples (PC1, PC2, PC3), in each of which the main unit cabinet 15 has a length of 315.6 mm, a width of 261.0 mm, a maximum thickness of 34.2 mm, and a minimum thickness of 31.2 mm. In the table, the data items indicate the sizes of the cracks having occurred in the main unit cabinet 15 and display cabinet (LCD) 23 and measured lengthways and widthways from corners 34 of the cabinets 15 and 23, respectively.

The average μ and standard deviation c of each of the widthways and lengthways sizes of the cracks were calculated. Further, μ−3σ and μ+3σ were calculated. It is generally known that the sizes of the cracks occurring in the main unit cabinet 15 and display cabinet 23 exhibit a normal distribution. Assuming that the sizes of the cracks occurring in the main unit cabinet 15 and display cabinet 23 exhibit a normal distribution, the sizes of the cracks occurring in 99.7% of all samples fall within a range of μ−3σ to μ+3σ from the characteristic of the standard distribution.

μ−3σ is a negative value in both width and length. Accordingly, the estimated lower limit concerning the sizes of the cracks is 0 mm. μ+3σ, which is the estimated upper limit concerning the sizes of the cracks occurring lengthways, is 40.42137 mm. Further, 15% of the length, 315.66 mm, of the main unit cabinet 15 and display cabinet 23 is 47.34 mm. Therefore, 15% of the entire length of the housing is sufficiently greater than the estimated upper limit concerning the lengthways sizes of the cracks.

Similarly, μ+3σ, which is the estimated upper limit concerning the sizes of the cracks occurring widthways, is 33.4087 mm. 15% of the width, 261.0 mm, of the main unit cabinet 15 and display cabinet 23 is 39.15 mm. Therefore, 15% of the entire width of the housing is sufficiently greater than the estimated upper limit concerning the widthways sizes of the cracks.

The inventors decided to locate the antennas 25 in areas away from the corners 34 by more than 15% of the length of the housing, i.e., to locate them away from the margin areas 33. This can prevent the antennas 25 from being damaged when the portable computer 11 has dropped. Although in the embodiment, the experimental results of only one type of computers are shown, it was confirmed that also in computers of different weights and sizes, cracks and damage concentratedly occur in the areas that are not away from the respective corners 34 by more than 15% of the length and width of the housing.

In the embodiment, as described above, the portable computer 11 comprises the housing, and the antennas 25 provided on the inner surface of the housing in the areas other than the corners 34 of the housing. Since thus, the antennas 25 are provided away from the corners 34 of the housing, i.e., of the display cabinet 23, they are prevented from being damaged along with the display cabinet 23 when, for example, the portable computer 11 has dropped.

More specifically, the antennas 25 are formed of metal films provided on the inner surface of the housing. Since in this case, the antennas 25 are formed of metal films provided on the inner surface of the display cabinet 23, no particular antenna spaces are necessary, thereby enhancing the efficient of use of the inner space of the display cabinet 23.

Although in the embodiment, the antennas 25 are formed on the display cabinet 23, the invention is not limited to this. Alternatively, the antennas 25 may be formed on the inner surface of the main unit cabinet 15 in areas away from the respective corners 34 by more than 15% of the length and width of the main unit cabinet 15.

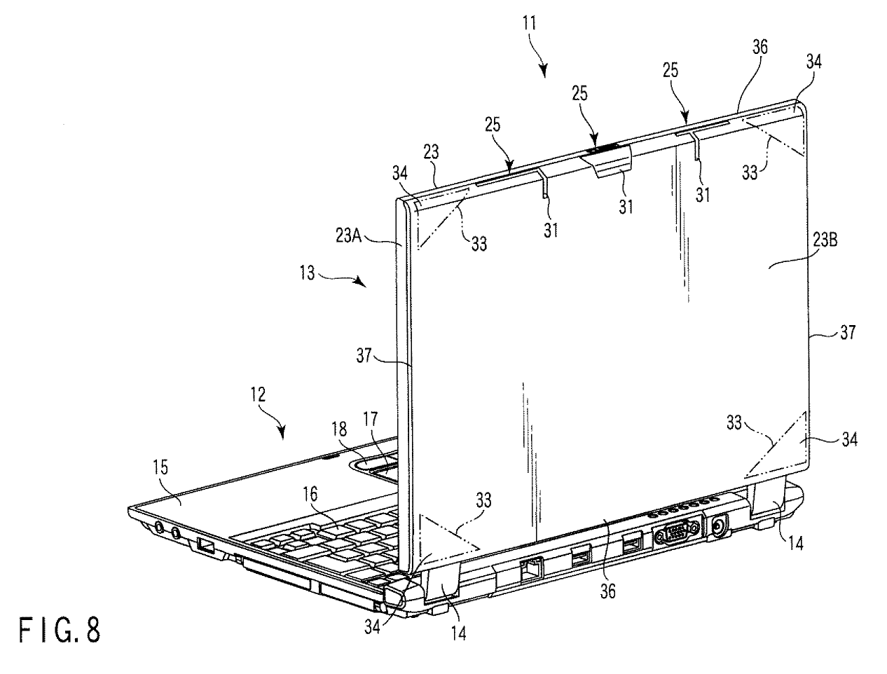

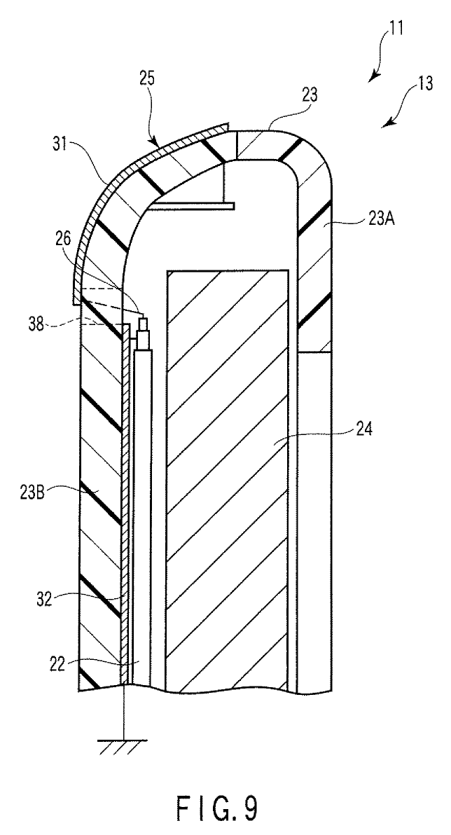

The portions on which the antennas 25 are provided are not limited to the above. The antennas 25 may be provided on the outer surface of the main unit cabinet 15 or display cabinet 23. When the antennas 25 are provided on the outer surface of the main unit cabinet 15, a through hole is formed in the main unit cabinet 15, through which the signal lines 26 of the coaxial cables 22 are inserted to electrically connect the radio modules 21 to the antenna elements 31 provided on the outer surface of the main unit cabinet 15. When the antennas 25 are provided on the outer surface of the display cabinet 23 as shown in FIG. 8, a through hole 38 is formed in the display cabinet 23 as shown in FIG. 9. The radio modules 21 are electrically connected to the antenna elements 31 on the outer surface of the display cabinet 23 by the signal lines 26 and coaxial cables 22 inserted through the through hole 38.

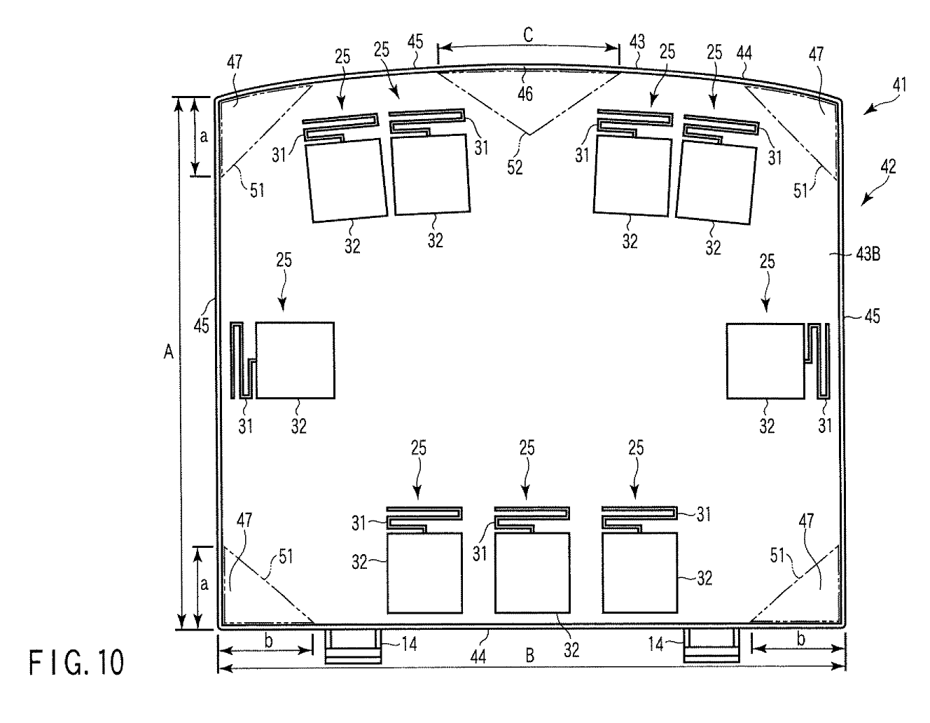

Referring then to FIG. 10, a portable computer 41 according to a second embodiment will be described. The portable computer 41 of the second embodiment differs from that of the first embodiment only in a display unit 42 incorporated therein. Therefore, elements similar to those of the first embodiment are denoted by corresponding reference numbers, and no description is given thereof.

The portable computer 41 comprises a main unit 12, a display unit 42, and hinges 14 interposed therebetween. The display unit 42 comprises a display cabinet 43 made of a resin, a liquid crystal display 24 contained in the display cabinet 23, and a plurality of antennas 25 built in the display cabinet 43. The display cabinet 43 has a front cover 43A and a rear cover 43B. The housing that will hereinafter be referred to includes the main unit cabinet 15 and the display cabinet 43.

The antennas 25 are formed as metal films on the inner surface of the rear cover 43B of the display cabinet 43. Each antenna 25 comprises an antenna element 31 and an antenna ground 32. Each antenna 25 is formed on the display cabinet 43 by, for example, inmold printing such as IMR or IMF, vapor deposition, plating or sputtering. Further, each antenna 25 may be formed by stacking, for example, copper, nickel and metal thin films using screen printing.

The rear cover 43B has four corners 47, first sides 44 extending between adjacent pairs of corners 47, and second sides 45 extending between adjacent pairs of corners 47 and being perpendicular to the first sides 44. One of the first sides 44 is formed arcuate to form a projection 46. The rear cover 43B includes first margin areas 51 located at positions corresponding to the corners 47, and a second margin area 52 located at a position corresponding to the projection 46. The first margin areas 51 are similar to the margin areas 33 of the first embodiment, and have a size a equal to 15% of the width A of the display cabinet 43, and a size b equal to 15% of the length B of the display cabinet 43.

The second margin area 52 is formed substantially triangular, and has a size c equal to 30% of the length of the display cabinet 43. The left-side area leftward extends from the center of the projection 46 and has a size equal to 15% of the length of the display cabinet 43. The right-side area rightward extends from the center of the projection 46 and has a size equal to 15% of the length of the display cabinet 43.

The antennas 25 are provided in areas other than the first margin areas 51 and second margin area 52, namely, other than the corners 47 and projection 46 of the display cabinet 43. The respective antennas 25 correspond to various schemes including communication schemes, such as Bluetooth (trademark), wireless LAN, wireless WAN, WiMAX, UWB and GPS, and portable telephone schemes, such as 3G and 3.5G.

In the second embodiment, since the antennas 25 are provided in areas other than the corners 47 and projection 46 of the display cabinet 43, the possibility of damaging the antennas 25 when the portable computer 41 has dropped can be minimized. In other words, since the antennas 25 are provided in areas away from the respective corners 47 by more than 15% of the length and width of the housing, and away from the projection 46 by more than 15% of the length of the housing, damage of the antennas 35 can be minimized.

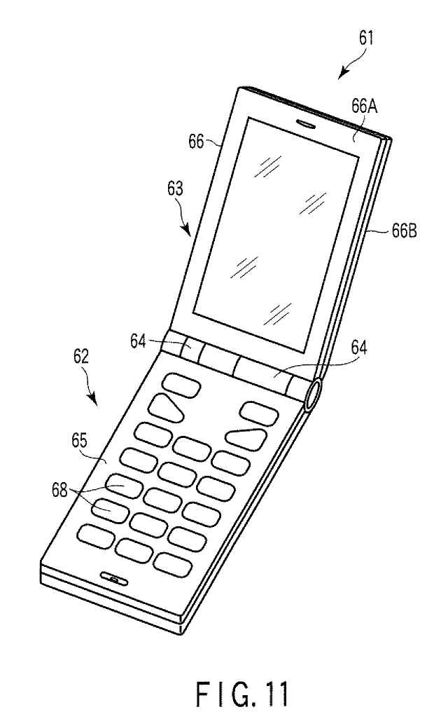

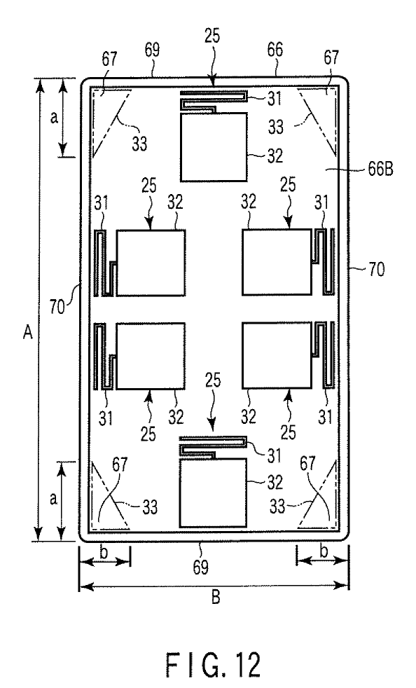

Referring then to FIGS. 11 and 12, an electronic apparatus according to a third embodiment will be described. The electronic apparatus is, for example, a portable telephone 61. In the third embodiment, elements similar to those of the first embodiment are denoted by corresponding reference numbers, and no description is given thereof.

As shown in FIG. 11, the portable telephone 61 comprises a main unit 62, a display unit 63, and hinges 64 interposed therebetween. The hinges 64 support the display unit 63 so that the unit 63 can rotate relative to the main unit 62.

The main unit 62 includes a main unit cabinet 65 and buttons 68, etc. The main body cabinet 65 has a conductive ground layer on its inner surface. The cabinet 65 of the main unit 62 contains a printed circuit board (not shown), a plurality of electronic components (not shown), and radio modules 21. The main unit 62 further includes coaxial cables 22 interposed between the main unit 62 and the display unit 63.

The display unit 63 comprises a display cabinet 66, a liquid crystal display 24 contained in the display cabinet 66, and a plurality of antennas 25 built in the display cabinet 66. The display cabinet 66 has a front cover 66A and a rear cover 66B. The housing that will hereinafter be referred to includes the main unit cabinet 65 and the display cabinet 66.

As shown in FIG. 12, the antennas 25 are formed on the rear cover 66B of the display cabinet 66. The antennas 25 are formed of metal films and provided on the inner surface of the rear cover 66B. Each antenna 25 comprises an antenna element 31 for transmitting/receiving electromagnetic waves, and an antenna ground 32 connected to the ground portion of the corresponding one of the coaxial cables 22. Each antenna 25 is formed on the display cabinet 66 by, for example, inmold printing such as IMR or IMF, vapor deposition, plating or sputtering. Further, each antenna 25 may be formed by stacking, for example, copper, nickel and metal thin films using screen printing.

The display cabinet 66 has four corners 67, first sides 69 extending between adjacent pairs of corners 67, and second sides 70 extending between adjacent pairs of corners 67 and being perpendicular to the first sides 69. The display cabinet 66 also has substantially triangular margin areas 33 at the corners 67. One side of each margin area 33 has a size a equal to 15% of the length A of the cabinet 66, and another side of each margin area 33 perpendicular to the one side has a size b equal to 15% of the width B of the cabinet 66.

The antennas 25 are formed in areas of the display cabinet 66 other than the margin areas 33. Namely, the antennas 25 are formed in areas apart from the corners 67 of the cabinet 66. The respective antennas 25 correspond to various schemes including communication schemes, such as Bluetooth (trademark), wireless LAN, wireless WAN, WiMAX, UWB and GPS, and portable telephone schemes, such as 3G and 3.5G.

In the third embodiment, the antennas 25 are formed on the inner surface of the housing away from the corners 67 of the housing. By virtue of this structure, also in the portable telephone 61, the possibility of damage of the antennas 25 can be reduced. In the third embodiment, since the antennas 25 are formed in areas away from the corners 67 by more than 15% of the length and width of the housing, damage of the antennas 25 can be minimized when the portable telephone 61 has dropped.

The electronic apparatuses of the above-mentioned embodiments can be modified in various ways without departing from the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions The accompanying claims and their equivalents are intended to cover such forms or modifications as would fall within the scope and spirit of the inventions.

What is claimed is:

1. An electronic apparatus comprising:
a housing including a corner, a first side extending from the corner, and a second side extending from the corner; and
an antenna provided in the housing, wherein the antenna is formed in an area located along the first side and apart from the corner by at least 15% of a size of the first side.

2. The electronic apparatus according to claim 1, wherein the antenna includes an antenna element and an antenna ground which are formed on an inner surface of the housing.

3. The electronic apparatus according to claim 1, further comprising a second antenna formed in an area located along the second side and apart from the corner by at least 15% of a size of the second side.

4. The electronic apparatus according to claim 1, further comprising a second corner as another end of the first side, and a second antenna formed in an area located along the first side and apart from the corner by at least 15% of a size of the first side.

5. The electronic apparatus according to claim 1, wherein the first side has a projection, and the antenna is located away from the corner by at least 15% of the size of the first side, and away from the projection by at least 15% of the size of the first side.

6. An electronic apparatus comprising:
a main unit;
a display unit rotatably attached to the main unit via a hinge, and including a corner, a first side extending from the corner, and a second side extending from the corner; and
an antenna provided in the display unit,
wherein the antenna is formed in an area located along the first side and apart from the corner by at least 15% of a size of the first side.

7. The electronic apparatus according to claim 6, wherein the antenna includes an antenna element and an antenna ground which are formed on an inner surface of the display unit.

8. The electronic apparatus according to claim 6, further comprising a second antenna formed in an area located along the second side and apart from the corner by at least 15% of a size of the second side.

9. The electronic apparatus according to claim 6, further comprising a second corner as another end of the first side, and a second antenna formed in an area located along the first side and apart from the corner by at least 15% of a size of the first side.

10. The electronic apparatus according to claim 6, wherein the first side has a projection, and the antenna is located away from the corner by at least 15% of the size of the first side, and away from the projection by at least 15% of the size of the first side.
